(19) United States
(12) Patent Application Publication
(10) Pub. No.: US 2026/0230749 A1
(43) Pub. Date: Aug. 6, 2026

(54) SYSTEM AND METHOD FOR IMPROVING ROBUSTNESS OF LOUDSPEAKER CONTROL IN ABNORMAL SITUATIONS

(71) Applicant: HARMAN INTERNATIONAL INDUSTRIES INCORPORATED, Stamford, CT (US)

(72) Inventors: Jiahe LIU, Shenzhen, Guangdong (CN); Tingyi WANG, Shenzhen, Guangdong (CN)

(73) Assignee: HARMAN INTERNATIONAL INDUSTRIES INCORPORATED, Stamford, CT (US)

(21) Appl. No.: 19/148,068

(22) PCT Filed: Jan. 20, 2023
(86) PCT No.: PCT/US2023/011288

§ 371 Date: Jul. 15, 2025

(51) Int. Cl. H04R 3/00; H04R 29/00

(52) U.S. Cl. CPC H04R 3/007; H04R 29/001

(57) ABSTRACT

In at least one embodiment, a loudspeaker system is provided. The at least loudspeaker system includes one loudspeaker comprising, an amplifier, and at least one controller. The at least one loudspeaker system transmits an audio output signal. The amplifier transmits a driving signal to the loudspeaker to transmit the audio output signal in response to a first audio signal. The controller includes a parameter estimation block that generates loudspeaker system parameters and a feed-forward processing block that models the loudspeaker system to provide the first audio signal to the amplifier based on modeled loudspeaker system parameters. The controller includes an adaption switch that controls the parameter estimation block based on at least one of a measured characteristic of the driving signal provided by the amplifier and a measured response associated with at least one characteristic of the at least one loudspeaker.

### TECHNICAL FIELD

Aspects disclosed herein generally relate to a system and method for improving robustness of loudspeaker control in abnormal situations. These aspects and others will be disclosed in more detail herein.

### BACKGROUND

An adaptive loudspeaker control system may work adequately under normal working conditions. However, in situations in which an unexpected interference acts on a loudspeaker system, parameter estimation may fail to produce correct parameter feedback. Examples of such interferences may include a user touching moving parts, a blocking of a port of a vented box, adhering a foreign substance onto a diaphragm of a loudspeaker, exposing the loudspeaker to water, etc.

Such interferences add uncorrelated noise into a measured response obtained from the loudspeaker control system. In addition, the interferences change the dynamics of a model that forms a parameter estimation for the loudspeaker control system. The changes cause estimated loudspeaker parameters to be unreliable, and consequently the protection and compensation functions in a feed-forward processing block of an amplifier may not operate properly. These aspects may then cause mechanical overshoots, excessive distortions, or even a complete failure due to the mechanical or thermal overdrive.

### SUMMARY

In at least one embodiment, a loudspeaker system is provided. The loudspeaker system includes at least one loudspeaker comprising, an amplifier, and at least one controller. The at least one loudspeaker transmits an audio output signal. The amplifier transmits a driving signal to the loudspeaker to transmit the audio output signal in response to a first audio signal. The at least one controller includes a parameter estimation block that generates loudspeaker system parameters and a feed-forward processing block that models the loudspeaker system for generating modeled loudspeaker system parameters and provides the first audio signal to the amplifier based on the modeled loudspeaker system parameters. The at least one controller includes an adaption switch that controls the parameter estimation block based on at least one of a measured characteristic of the driving signal provided by the amplifier and a measured response associated with at least one characteristic of the at least one loudspeaker.

In at least one embodiment, a loudspeaker system is provided. The loudspeaker system includes at least one loudspeaker comprising, an amplifier, and at least one controller. The at least one loudspeaker transmits an audio output signal. The amplifier transmits a driving signal to the loudspeaker to transmit the audio output signal in response to a first audio signal. The at least one controller includes a parameter estimation block programmed to generate loudspeaker system parameters and a feed-forward processing block programmed to model the loudspeaker system parameters and to provide the first audio signal to the amplifier based on the modeled loudspeaker system parameters. The at least one controller further includes a protection control block programmed to transmit a threshold to the feed-forward processing block to adjust the driving signal to mechanically protect the at least one loudspeaker.

In at least one embodiment, a method for controlling a loudspeaker system is provided. The method includes transmitting an audio output signal via at least one loudspeaker and providing the driving signal from an amplifier to the loudspeaker to transmit the audio output signal in response to a first audio signal. The method further includes generating, via at least one controller, loudspeaker system parameters and modeling the loudspeaker system to provide the first audio signal to the amplifier based on modeled loudspeaker system parameters. The method further includes controlling the at least one controller based on at least one of a measured characteristic of the driving signal provided by the amplifier and a measured response associated with at least one characteristic provided the at least one loudspeaker.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 depicts one example of an adaptive feed-forward control of a loudspeaker system;

FIG. 2 depicts one example of a parameter estimation block as used with the adaptive feed-forward control of FIG. 1;

FIG. 3 depicts the adaptive feed-forward control of the loudspeaker system of FIG. 1 that experiences interference;

FIG. 4 depicts an adaptive feed-forward control for a loudspeaker system in accordance with one embodiment;

FIG. 5 depicts a first method for performing adaptive switching for the loudspeaker system in accordance with one embodiment;

FIG. 6 depicts a method for performing protection control for the loudspeaker system in accordance with one embodiment;

FIG. 7 depicts an example of error-threshold mapping for the method of FIG. 6 in accordance with one embodiment;

FIG. 8 depicts one example of a fitting error for the parameter estimation in accordance with one embodiment;

FIG. 9 depicts one example of displacement thresholds for a loudspeaker driver and passive radiator in accordance with one embodiment; and

FIG. 10 depicts loudspeaker system parameters in accordance with one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aspects disclose herein provides a robust operation of adaptive loudspeaker control algorithms. For example, the disclosed systems and methods may turn off various parameters for a parameter estimation block in a loudspeaker system to update in abnormal situations by checking the level, continuity, and coherence of the measured voltage and response signal. The disclosed systems and methods may adaptively reduce mechanical protection threshold if a modeling error is large. Using the disclosed systems and methods, a loudspeaker control system (or loudspeaker system) may be more robust in abnormal situations, for example, operating under outside interference or when the parameters are not yet converged.

In principle, the measured response may be any physical quantities that include state information of the loudspeaker system. For example, voice coil current, in-box pressure, displacement, velocity, or acceleration of a loudspeaker driver, passive radiator (PR), and vent air. The overall scheme of protection threshold controls may be generalized as a loudspeaker system equipped with sensors that reduces its outputs if an outside interference being applied to the loudspeaker system.

In general, an adaptive loudspeaker control system may work as desired under normal operating conditions. However, in situations in which unexpected outside interference acts on the loudspeaker system, the parameter estimation may fail to produce correct parameter feedbacks. Examples of interference may include users touching moving parts of the loudspeaker system, blocking the port of a vented-box, adhering something to the diaphragm, exposing the loudspeaker to water, etc. These interferences either add uncorrelated noise into the measured response or change the dynamics of the physical system so that the model inside the parameter estimation block cannot capture. The estimated parameters may be unreliable, and consequently, the protection and compensation functions in a feed-forward processing block will not operate properly, causing mechanical overshoots, excessive distortions, or even complete failure due to mechanical or thermal overdrive. The discloses systems and methods makes loudspeaker protection and compensation system more robust in abnormal situations. More specifically, the parameter feedback is more stable and less sensitive to short-term, uncorrelated interference from outside. In addition, the risk of mechanical overshoots and excessive distortions caused by incorrect parameters are reduced. Such incorrect parameters often occur under outside interference or if the parameters have not converged.

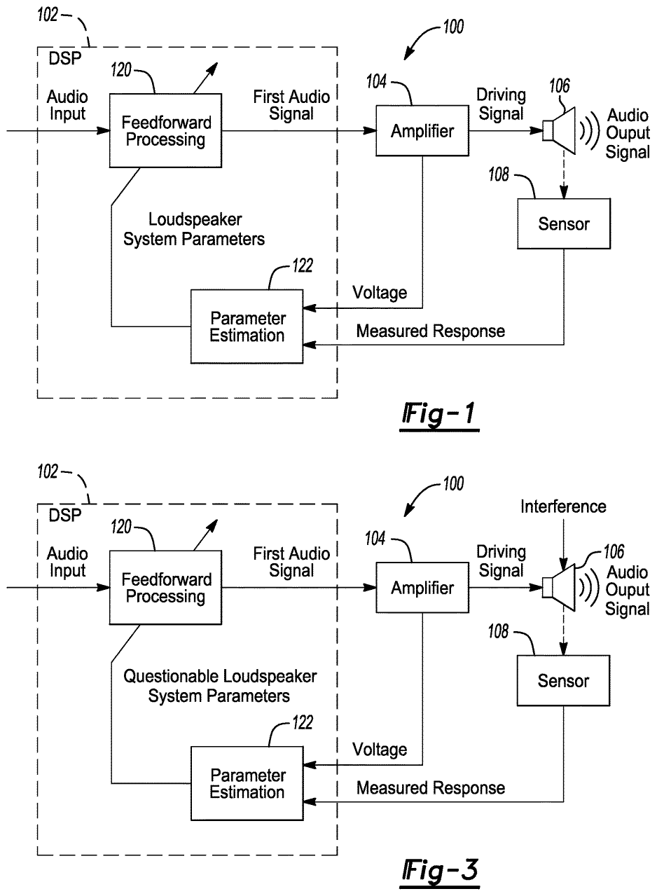

FIG. 1 depicts one example of an adaptive feed-forward control for a loudspeaker system 100. The system 100 generally includes at least one digital signal processor (DSP) 102 (or at least one controller 102 (hereafter “the controller 102”)), an amplifier 104, at least one loudspeaker 106 (hereafter “the loudspeaker 106”), and at least one sensor 108 (hereafter “the sensor 108”). In one example, the sensor 108 may be a microphone. The controller 102 includes a feed-forward processing block 120 and a parameter estimation block 122. The feed-forward processing block 120 and the parameter estimation block 122 form a control block within the controller 102 for controlling audio transmitted by the loudspeaker 106.

In general, model-based loudspeaker control algorithms are becoming increasingly popular for their ability to improve sound quality of a given loudspeaker system. One example of a such a model-based loudspeaker control algorithm is SmartPA technology which has been widely used for micro-loudspeakers on mobile devices. In general, the control algorithms usually follow the framework of adaptive feed-forward control which is illustrated in FIG. 1. The feed-forward processing block 120 provides sound enhancement functions which may include mechanical and thermal protection, nonlinear compensation, and automatic equalization for the loudspeaker 106 (or for the system 100). The feed-forward processing block 120 may be based on modeling the loudspeaker system 100 and the performance of the feed-forward processing block 120 may rely on the accuracy of the model. On the other hand, the transfer characteristics of real loudspeaker systems has large uncertainties due to production variance and time-varying effects. For this reason, the parameter estimation block 122 may be needed to update the parameters of the model in real-time to ensure the alignment between the feed-forward processing block 120 and the actual loudspeaker system being controlled. The embodiments as disclosed herein may improve the robustness of the system 100.

The controller 102 provides a first audio signal to the amplifier 104. The amplifier 104 amplifies the first audio signal to provide a driving signal (or stimulus voltage) that is provided to the loudspeaker 106. The amplifier 104 provides a measured voltage corresponding to the driving signal that is transmitted to the loudspeaker 106. In general, the amplifier 104 provides the stimulus voltage (or the driving signal) to drive the loudspeaker 106 to generate an audio output signal. The sensor 108 picks up or senses a characteristic associated with the loudspeaker 106 and transmits a signal as a measured response to the parameter estimation block 122. The measured response generally corresponds to a responding signal of the loudspeaker 106 as the stimulus voltage is being applied. The sensor 108 generally detects any one or more of the characteristics such as a voice coil current, an in-box pressure, a displacement, a velocity, an acceleration of a driver for the loudspeaker 106, a passive radiator (PR) for the loudspeaker 106, and vented air for the loudspeaker 106. Thus, in this regard, any one or more of the characteristics noted above may correspond to the measured response.

Depending on which response signal or loudspeaker characteristic is measured, the sensor 108 may correspond to circuitry for sensing current, a microphone, a vibration sensing laser, a vibration sensing capacitor, or an accelerometer. The parameter estimation block 122 models various transfer characteristics between the measured voltage and the measured response.

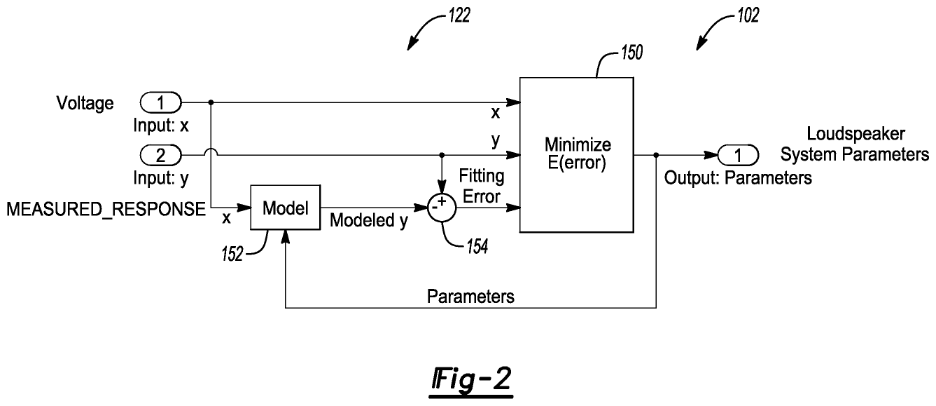

FIG. 2 depicts one example of the parameter estimation block 122 of the controller 102 as used with the adaptive feed-forward control of FIG. 1. The parameter estimation block 122 includes a minimization block 150, a modeling block 152, and an adder block 154. The parameter estimation block 122 takes the voltage and at least one measured response of the loudspeaker system 100 as the inputs. The parameter estimation block 122 utilizes the modeling block 152 to model parameters (or transfer characteristics) for the loudspeaker 106 between the two measured signals (e.g., x and y as shown in FIG. 2). The parameters of the model are estimated by algorithms by the modeling block 152 and at least one output is provided to the minimization block 150 as an error signal to minimize an error between the modeled output and the measured output. It is recognized that the voltage and measured response signals can be switched relative to those shown in FIG. 2.

FIG. 3 depicts the adaptive feed-forward control for the loudspeaker system 100 of FIG. 1 that experiences interference. The system 100 generally performs reasonably well under normal conditions. However, in certain situations, the system 100 experiences outside interference and the parameter estimation block 122 may generate incorrect parameters for controlling various aspects (e.g., parameters) for the loudspeaker 106. Examples of interference may include users touching moving parts of the loudspeaker 106, blocking ports of a vented-box associated with the loudspeaker 106, exposing the loudspeaker 106 to water, etc. These interferences may add uncorrelated noise into the measured response of the loudspeaker system 100. In addition, the interferences may change the dynamics of the physical system (e.g., the loudspeaker 106) so that the model of the parameter estimation block 122 may not correctly adapt the parameters for the loudspeaker 106. Thus, the estimated loudspeakers parameters may be unreliable, and consequently the feed-forward processing block 120 may not operate properly thereby causing mechanical overshoots, excessive distortions, or even a complete failure due to the mechanical or thermal overdrive. Various mechanisms may be needed to ensure the robust operation under such interferences.

The SmartPA technology as noted above may be used for micro-loudspeakers on smartphones, tablets, and laptops, where the loudspeaker enclosure is usually a closed-box, and the front outlet is protected by a grille. The outside interference is minimized, and the most possible case may involve the outlet grill being blocked. In this case, the displacement of the diaphragm may actually become smaller, so this may not cause any serious problem.

This however is not the case for larger products where acoustic radiation surfaces (loudspeaker diagram, passive radiators, port outlets) are often directly exposed to the outside, making these larger products more prone to the interference. It may also be more problematic for higher order systems such as the vented-box and the passive radiator systems. For example, blocking the vent of a vented-box may increase the displacement of the loudspeaker diaphragm in a certain frequency range. This may also change the dynamics of the system so that the parameters are unable to converge at all.

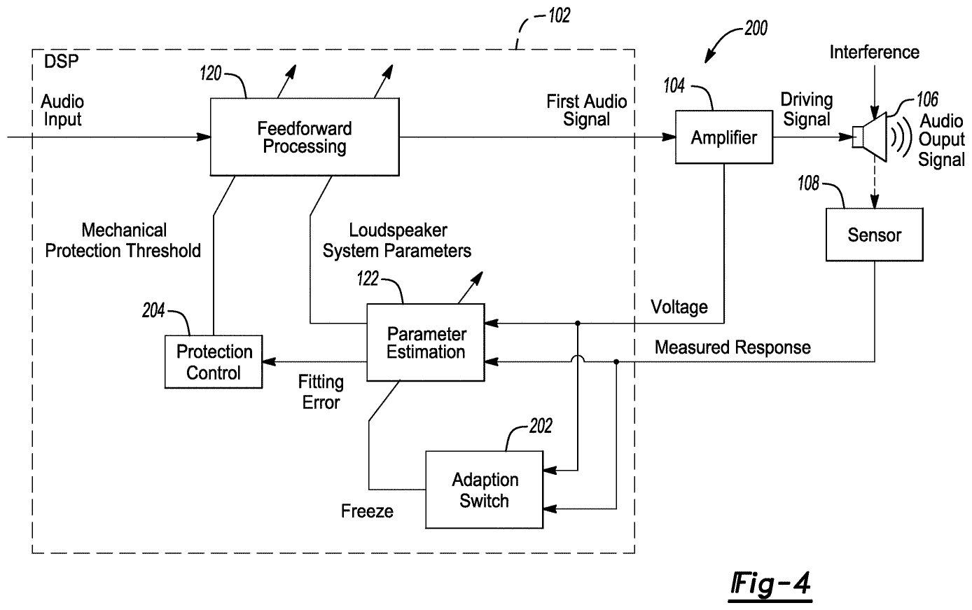

FIG. 4 depicts an adaptive feed-forward control for a loudspeaker system 200 in accordance with one embodiment. The system 200 includes the controller 102, the amplifier 104, the loudspeaker 106, and the sensor 108 as noted above in connection with FIG. 1. The system 200 also includes an adaption switch 202 and a protection control block 204 within the controller 102. The adaption switch 202 is operably coupled to the parameter estimation block 122 and receives the voltage from the amplifier 104 and the measured response from the sensor 108.

The adaption switch 202 checks whether the voltage from the amplifier 104 and the measured response from the sensor 108 is suitable for updating model parameters as provided by the parameter estimation block 122. If the adaption switch 202 determines that the measured response and the voltage are not suitable, the adaption switch 202 controls the parameter estimation block 122 to freeze the adaption and to output parameters from a previous frame. While not shown, it is recognized that the voltage and the measured response may be transmitted to the parameter estimation block 122 and the adaption switch as digital inputs (or frames) and that analog to digital converters (ADCs) (not shown) may be positioned between the parameter estimation block 122 and the amplifier 104 and the sensor 108 to convert analog variants of the measured response and the voltage into digital data for processing by the parameter estimation block 122 and the adaption switch 202.

The protection control block 204 computes or determines a mechanical protection threshold for the feed-forward processing block 120 in response to a model fitting error signal (or model fitting error). The parameter estimation block 122 determines and provides the model fitting error as provide from the output of the adder block 154 as shown in connection with FIG. 2. If the protection control block 204 determines that the fitting error is large (e.g., is above a threshold), such a large fitting error is indicative that the model is unreliable. In this case, the protection control block 204 reduces a protection threshold value to protect the system 200.

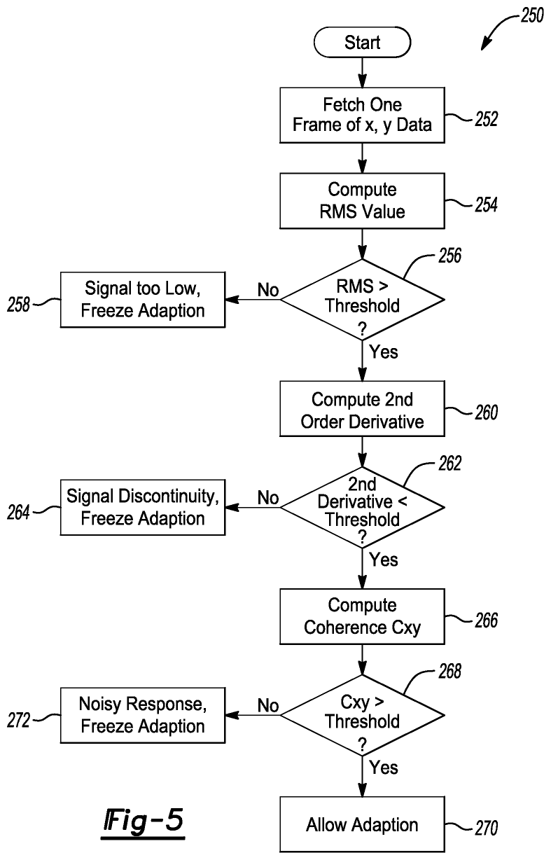

FIG. 5 depicts a first method 250 for performing adaptive switching for the loudspeaker system 200 in accordance with one embodiment. The controller 102 executes the first method 250 to determine whether a current frame of the input signal (e.g., the voltage from the amplifier 104 or the measured response from the sensor 108) is suitable for parameter update. The first method 250 as illustrated in connection with the adaption switch 202 may require the conditions as set forth in operation 256, 262, and 268. These aspects will be discussed in more detail below. In operation 252, the controller 102 fetches (or obtains) a frame of data corresponding to the voltage from the amplifier 104 and the measured response from the sensor 108 (or microphone).

In operation 254, the controller 102 computes a root mean square (RMS) value for the measured voltage and the measured response. The controller 102 computes the RMS value for the measured voltage and the measured response to ensure that the stimulus voltage and/or measured response is large. For example, the controller 102 may calculate the RMS value based on the following equation:

$${x}_{rms} = \sqrt{{\sum }_{i} {x}_{i}^{2}} ,$$

where i is the sample index in a frame of data

It is recognized that variable x as set forth above may correspond to the measured voltage as output by the amplifier 104 or the measured response as provided by the sensor 108.

In operation 256, the controller 102 compares the calculated RMS value to a threshold. For example, the controller 102 compares the calculated RMS value for the voltage to a first threshold and a calculated RMS value for the measured response to a second threshold. It is recognized that the first threshold and the second threshold may either correspond to the same value or be equal to one another, or to different values. If any one or more of the calculated RMS value for the measured voltage or for the measured response is less than the first threshold or the second threshold, respectively, then the method 250 moves to operation 258. If not, then the method 250 moves to operation 260.

In operation 258, the controller 102 determines the signal (e.g., the measured voltage and/or the measured voltage response) is too low and controls the parameter estimation block 122 to freeze or stop calculating parameter estimation values for the feed-forward processing block 120 until new data is available.

In operation 260, the controller 102 calculates a second order derivative test. For example, the controller 102 calculates the second order derivative test to determine if there are any discontinuities in the measured voltage or the measured response. Such discontinuities correspond to consequences of software issue or are otherwise attributable to software issues associated with controller 102 which may negatively impact the parameter estimation block 122. For example, the controller 102 may calculate the second order (2^{nd}) derivative test (e.g., d₂(n)) based on the following equation:

$${d}_{2} ( n ) = \frac{x ( n ) - 2 x ( n - 1 ) + x ( n - 2 )}{{h}^{2}} ,$$

where h is the sample interval.

It is recognized that variable x as set forth above may correspond to the measured voltage as output by the amplifier 104 or the measured response as provided by the sensor 108.

In operation 262, the controller 102 compares the calculated second order derivative to a threshold. For example, the controller 102 compares the second order derivative for the voltage to a first threshold and the second order derivative for the measured response to a second threshold. It is recognized that the first threshold and the second threshold may either correspond to the same value or be equal to one another, or to different values. If any one or more of the calculated second order derivatives for the measured voltage or for the measured response is greater than the first threshold or the second threshold, respectively, then the method 250 moves to operation 264. If not, then the method 250 moves to operation 266.

In operation 264, the controller 102 determines that there are discontinuities in the measured voltage and/or the measured response and freezes adaption. In this case, the controller 102 determines the signal (e.g., the measured voltage and/or the measured voltage response) is indicative of discontinuities in the system 200 and controls the parameter estimation block 122 to freeze or stop calculating parameter estimation values for the feed-forward processing block 120 until new data is available.

In operation 266, the controller 102 performs a coherency test. For example, the controller 102 calculates a coherence Cxy for the measured voltage and the measured response. The coherence Cxy corresponds to an estimation of the extent in which a signal y (e.g., a signal corresponding to the measured response) is linearly correlated with a signal x (e.g., a signal corresponding to the measured voltage). The coherence Cxy is generally a function of the frequency and may be defined as:

$${C}_{x y} ( f ) = \frac{{\vert {S}_{x y} ( f ) \vert}^{2}}{{S}_{xx} ( f ) {S}_{y y} ( f )} ,$$

where Sₓₓ, S_{yy}, and S_{xy} are the estimations of power spectrums and cross-power spectrum of the signal x (e.g., the measured voltage) and y (e.g., the measured response). These values may be calculated using various methods, for example the exponentially averaged periodograms:

$${S}_{x x} ( f , k ) = α {X ( f , k )}^{*} X ( f , k ) + ( 1 - α ) {S}_{x x} ( f , k - 1 )$$

$${S}_{x y} ( f , k ) = α {X ( f , k )}^{*} Y ( f , k ) + ( 1 - α ) {S}_{x y} ( f , k - 1 ) ,$$

where k is the index of each input frame (e.g., for the measured voltage and the measured response), X and Y are the spectrums of a frame of x and y that is obtained by Discrete Fourier Transform and a is a factor that controls the averaging speed.

Under normal conditions, Cxy is close to 1. With outside interference, especially when the interference initially starts to act on the system 200, the coherence will drop significantly due to the uncorrelated components added into the response y. The coherence test detects this situation and freeze the parameter update.

In operation 268, the controller 102 determines whether the coherence Cxy is greater than a threshold. If this condition is true, then the method 250 proceeds to operation 270. If not, then the method 250 proceeds to operation 272. In operation 270, the controller 102 allows the parameter estimation block 122 to perform adaption (e.g., provide loudspeaker parameters to the feed-forward processing block 120). In operation 272, the controller 102 determines that the interference is too noisy and controls the parameter estimation block 122 to freeze or to refrain from updating the loudspeaker parameters. In this case, the controller 102 determines that the measured response (i.e., signal y) has a signal component that did not come from the measured voltage (i.e., the signal x) and that such a signal component may be attributed to the interference.

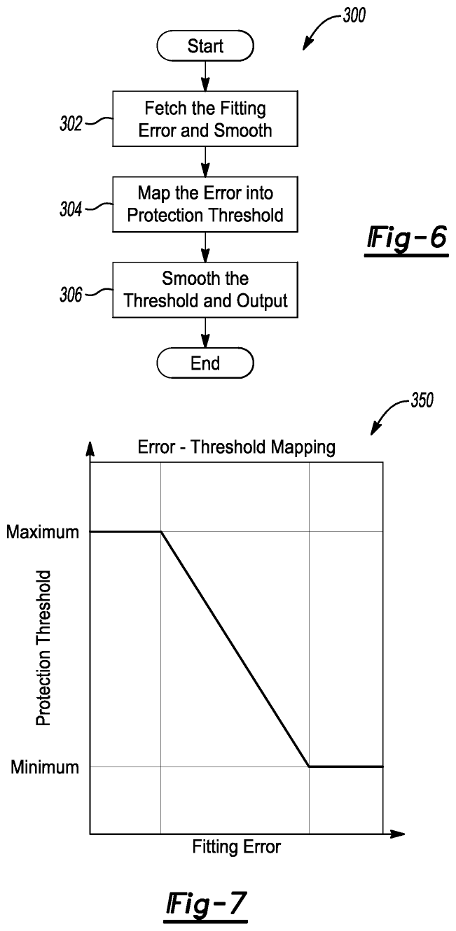

FIG. 6 depicts a method 300 for performing protection control for the loudspeaker system 200 in accordance with one embodiment. In general, the operations identified in connection with the method 300 may be performed by the protection control block 204. In general, the controller 102 utilizes the fitting error to generate a safe protection threshold for the mechanical protection parameters for the loudspeaker 106 when executed by the feed-forward processing block 120. The feed-forward processing block 120 may generally reduce the gain of the first audio signal in response to the feed-forward processing block 120 detecting that the predicted (or modeled) mechanical characteristics exceed the thresholds as set forth by the protection control block 204. The feed-forward processing block 120 includes a digital loudspeaker model stored within the controller 102 to generate the predicted mechanical characteristics. The parameter estimation block 122 generates the fitting error based on the measured voltage and the measured response.

In operation 302, the controller 102 obtains the fitting error as provided by the parameter estimation block 122. In operation 304, the controller 102 maps the fitting error as obtained in operation 302 on top to the error-threshold mapping table 350 as shown in FIG. 7. A large fitting error is generally indicative that the model as provided by the system 200 is unreliable. In operation 306, the controller 102 smooths (or moves) the protection threshold. For example, the higher the fitting error, the controller 102 reduces the threshold as exhibited in the table 350 (note-a high fitting error (see x-axis) results in a smaller protection threshold as exhibited on the y-axis). In this case, the system 200 operates in more conservative range due to the reduced threshold. Conversely, the lower the fitting error, the higher the threshold as also shown in FIG. 7. In general, the controller 102 takes an average of a predetermined number of samples of the fitting error signal. The method 300 may be executed irrespective of state of the adaption control. In addition to protecting the system 200 under uncoherent interference, the method 300 is also active during the converging phase, for example, when the system 200 has just been turned on and the exact parameters are not certain (or unpredictable).

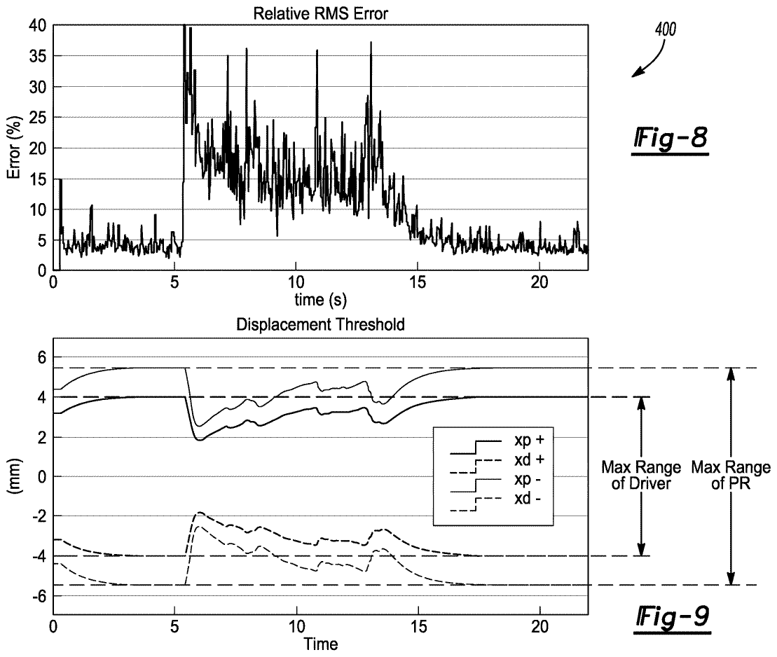

FIG. 8 corresponds to a plot 400 exhibiting one example of a fitting error for the parameter estimation in accordance with one embodiment. As shown the plot 400, as the interference is applied at 5.2s (see x-axis), the fitting error increases, and the protection threshold starts to drop (see y-axis). During the time interval of interference, the estimated parameters provided by the parameter estimation block 122 are clearly “wrong”, especially for those directly associated with passive radiators (PRs). Though the model cannot fully capture the dynamics, the model tries to fit the measurement as best as it can. In this case, the fitting error is dropped to around 20% after the interference was initially applied. The protection thresholds are also released at a milder pace. At 12.5s, the interference was removed. The threshold is not released to its maximum values until the parameters are converged at around 15s.

FIG. 9 depicts one example of displacement thresholds for a loudspeaker driver and passive radiator in accordance with embodiment. The thresholds as shown are generated by the protection control block 204 in accordance to the method 300 as described above.

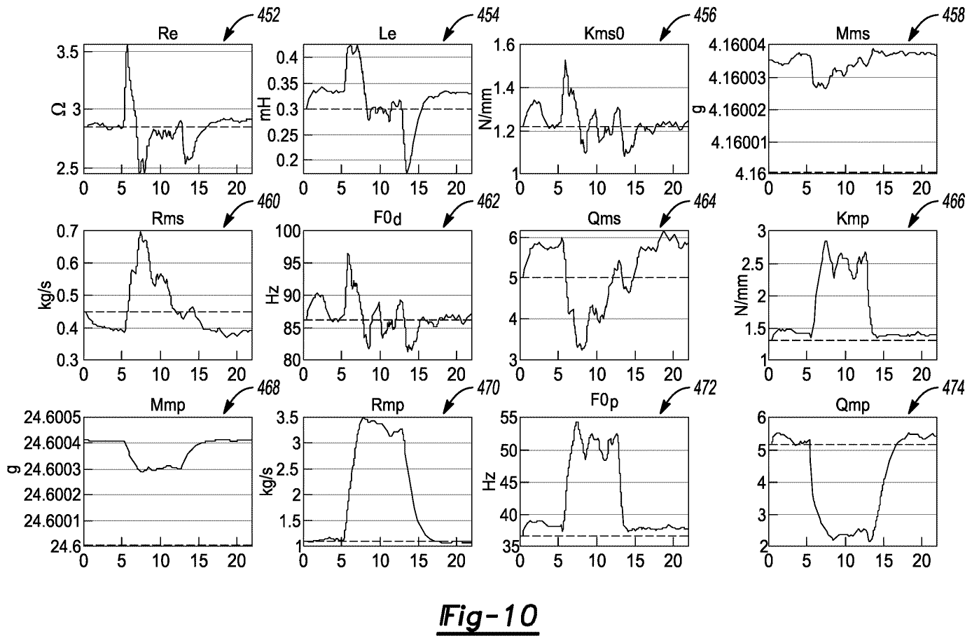

FIG. 10 depicts loudspeaker system parameters 452-474 in accordance with one embodiment. The system parameters 452-474 as illustrated coincide with the thresholds as shown in the plot 400. Parameter 452 corresponds to a voice coil resistor, parameter 454 corresponds to a voice coil inductance, parameter 456 corresponds to a stiffness of a loudspeaker suspension, parameter 458 corresponds to a moving mass of a loudspeaker driver, parameter 460 corresponds to a mechanical resistance of a loudspeaker driver, parameter 462 corresponds to a resonance frequency of a loudspeaker driver, parameter 464 corresponds to a Q factor, parameter 466 corresponds to mechanical stiffness of a passive radiator, parameter 468 corresponds to a moving mass of a passive radiator, parameter 470 corresponds to a mechanical resistance of a passive radiator, parameter 472 corresponds to a resonance frequency of a passive radiator, and parameter 474 corresponds to a Q factor of a passive resistor. For each of the parameters 452-474 and as noted in connection with FIG. 8, it can be seen that interference is applied at generally 5.2 seconds. In addition, at generally 12.5 seconds, the interference is removed and the parameters 452-474 start to stabilize thereafter as time increases.

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A loudspeaker system comprising:
at least one loudspeaker to transmit an audio output signal;
an amplifier to transmit a driving signal to the loudspeaker to transmit the audio output signal in response to a first audio signal; and
at least one controller including:
a parameter estimation block programmed to generate loudspeaker system parameters;
a feed-forward processing block programmed to model the loudspeaker system for providing modeled loudspeaker system parameters and to provide the first audio signal to the amplifier based on the modeled loudspeaker system parameters; and
an adaption switch programmed to control the parameter estimation block based on at least one of a measured characteristic of the driving signal provided by the amplifier and a measured response associated with at least one characteristic of the at least one loudspeaker.

2. The loudspeaker system of claim 1, wherein the adaption switch is further programmed to control the parameter estimation block by one of enabling the parameter estimation block to generate the loudspeaker system parameters and causing the parameter estimation block to refrain from generating the loudspeaker system parameters based on at least one of the measured characteristic of the driving signal provided by the amplifier and a measured response associated with the at least one characteristic of the at least one loudspeaker.

3. The loudspeaker system of claim 2, wherein the adaption switch is further programmed to cause the parameter estimation block to generate the loudspeaker system parameters by enabling the parameter estimation block to generate a previous set of loudspeaker system parameters based at least on one of a previously measured characteristic of the driving signal provided by the amplifier and a previously measured response associated with the at least one characteristic of the at least one loudspeaker.

4. The loudspeaker system of claim 1, wherein the measured characteristic of the driving signal provided by the amplifier is a voltage of the driving signal that drives the at least one loudspeaker.

5. The loudspeaker system of claim 1 further comprising a protection control block programmed to transmit a threshold to the feed-forward processing block to adjust the first audio signal to mechanically protect the at least one loudspeaker.

6. The loudspeaker system of claim 5, wherein the protection control block is further programmed to adjust the threshold based on a fitting error signal.

7. The loudspeaker system of claim 6, wherein the fitting error signal is based on at least the modeled loudspeaker system parameters and on one of the measured characteristic of the driving signal provided by the amplifier and the measured response associated with the at least one characteristic of the at least one loudspeaker.

8. The loudspeaker system of claim 6, wherein the protection control block is further programmed to adjust the threshold by one of increasing or decreasing the threshold based on a value of the fitting error signal.

9. The loudspeaker system of claim 6, wherein the fitting error signal increases in response to the at least one loudspeaker exhibiting an interference condition.

10. A loudspeaker system comprising:
at least one loudspeaker to transmit an audio output signal;
an amplifier to transmit a driving signal to the least one loudspeaker to transmit the audio output signal in response to a first audio signal;
at least one controller including:
a parameter estimation block programmed to generate loudspeaker system parameters;
a feed-forward processing block programmed to model the loudspeaker system for providing modeled loudspeaker system parameters and to provide the first audio signal to the amplifier based on the modeled loudspeaker system parameters; and
a protection control block programmed to transmit a threshold to the feed-forward processing block to adjust the driving signal to mechanically protect the at least one loudspeaker.

11. The loudspeaker system of claim 10, wherein the protection control block is further programmed to adjust the threshold based on a fitting error signal.

12. The loudspeaker system of claim 11, wherein the fitting error signal is based on at least the modeled loudspeaker system parameters and on one of a measured characteristic of the driving signal provided by the amplifier and a measured response associated with at least one characteristic of the at least one loudspeaker.

13. The loudspeaker system of claim 11, wherein the protection control block is further programmed to adjust the threshold by one of increasing or decreasing the threshold based on a value of the fitting error signal.

14. The loudspeaker system of claim 11, wherein the fitting error signal increases in response to the at least one loudspeaker exhibiting an interference condition.

15. The loudspeaker system of claim 11 further comprising an adaption switch programmed to control the parameter estimation block based on at least the modeled loudspeaker system parameters and on at least one of a measured characteristic of the driving signal provided by the amplifier and a measured response associated with at least one characteristic of the at least one loudspeaker.

16. The loudspeaker system of claim 15, wherein the at least one characteristic of the at least one loudspeaker corresponds to one of a voice coil current, an in-box pressure, a displacement of the loudspeaker, a velocity of the loudspeaker, an acceleration of a driver for the loudspeaker, a passive radiator (PR) for the loudspeaker, and a vented air for the loudspeaker.

17. The loudspeaker system of claim 15, wherein the adaption switch is further programmed to control the parameter estimation block by on one of enabling the parameter estimation block to generate the loudspeaker system parameters and causing the parameter estimation block to refrain from generating the loudspeaker system parameters based on the at least the modeled loudspeaker system parameters and on one of a measured characteristic of the driving signal provided by the amplifier and the measured response associated with the at least one characteristic of the at least one loudspeaker.

18. The loudspeaker system of claim 17, wherein the adaption switch is further programmed to cause the parameter estimation block to generate the loudspeaker system parameters by enabling the parameter estimation block to generate a previous set of loudspeaker system parameters based at least on a previously measured characteristic of the driving signal provided by the amplifier and a previously measured response associated with the at least one characteristic of the at least one loudspeaker.

19. The loudspeaker system of claim 15, wherein the measured characteristic of the audio output signal provided by the amplifier is a voltage of the driving signal transmitted by the amplifier to drive the at least one loudspeaker.

20. A method for controlling a loudspeaker system, the method comprising:
transmitting an audio output signal via at least one loudspeaker;
providing a driving signal from an amplifier to the loudspeaker to transmit the audio output signal in response to a first audio signal;
generating, via at least one controller, loudspeaker system parameters;
modeling the loudspeaker system to provide modeled loudspeaker system parameters and providing the first audio signal to the amplifier based on the modeled loudspeaker system parameters; and
controlling the at least one controller based on at least one of a measured characteristic of the driving signal provided by the amplifier and a measured response associated with at least one characteristic provided the at least one loudspeaker.
